(19) United States
(12) Patent Application Publication
(10) Pub. No.: US 2006/0238671 A1
(43) Pub. Date: Oct. 26, 2006

(54) Photo-luminescence liquid crystal display

(75) Inventors: Byung-ki Kim, Gunpo-si (KR); Seung-jae Im, Seoul (KR); Jae-young Choi, Suwon-si (KR); Yoon-sok Kang, Seongnam-si (KR); Seon-mi Yoon, Yongin-si (KR); Jae-hee Cho, Yongin-si (KR)

Correspondence Address: BUCHANAN, INGERSOLL & ROONEY PC, POST OFFICE BOX 1404, ALEXANDRIA, VA, 22313-1404, US

(73) Assignee: Samsung Electronics Co., Ltd., Suwon-si (KR)

(21) Appl. No.: 11/336,815

(22) Filed: Jan. 23, 2006

(30) Foreign Application Priority Data
Apr. 20, 2005 (KR) 10-2005-0032738

(51) Int. Cl. G02F 1/1335

(52) U.S. Cl. 349/71

(57) ABSTRACT

A photo-luminescence (PL) liquid crystal display (LCD) is provided. The PL LCD includes a blue backlight, red and green phosphor layers, and blue photo-luminescent nano-dot (ND) layer. The PL LCD improves conventional problems of a narrow viewing angle and orientation. The PL LCD further includes an ultraviolet (UV) filter blocking UV contained in ambient light, thus preventing excitation of light-emitting layer due to external light and degradation in the contrast ratio due to unnecessary light emission.

### CROSS-REFERENCE TO RELATED PATENT APPLICATION

This application claims the benefit of Korean Patent Application No. 10-2005-0032738, filed on Apr. 20, 2005, in the Korean Intellectual Property Office, the disclosure of which is incorporated herein in its entirety by reference.

### BACKGROUND OF THE DISCLOSURE

1. Field of the Disclosure

The present disclosure relates to a liquid crystal display (LCD) and a photo-luminescence (PL)-LCD with high light utilization efficiency.

2. Description of the Related Art

LCDs are non-emissive displays and need a separate backlight device to display an image on a screen. LCDs also require Red (R), Green (G), and Blue (B) color filters for their respective pixels to display a color image.

The R, G, and B color filters respectively separate white light emitted from a backlight device into red, green, and blue. The R, G, and B color filters each transmit only light of a specific wavelength that is one third of white light, resulting in significant optical loss. Thus, a high brightness backlight device is needed to produce an image with sufficient brightness.

With high light utilization efficiency, PL-LCDs using phosphors excited by ultraviolet (UV) light instead of color filters have been disclosed in U.S. Pat. Nos. 4,822,144 and 4,830,469.

In U.S. Patent Publication No. 2002/0145,685, Regina et al. propose a PL-LCD using a blue backlight and red and green phosphors. The blue backlight simply switches a light path using liquid crystal instead of a color filter or phosphors. The red and green phosphors are excited by blue light from the blue backlight switched by the liquid crystal.

The drawback of the proposed PL-LCD is that it has a narrow viewing angle and orientation because light emitted from a blue pixel has a polarization component. The blue pixel with a polarization component and a narrow viewing angle has different optical characteristics than red and green pixels with no polarization component and a wide viewing angle.

The phosphors for the red and green pixels are excited by the blue backlight as well as ambient light incident from an external light source since the ambient light also contains blue UV as well. The UV contained in the ambient light unnecessarily excites the phosphors without contributing to displaying an image on the LCD, thereby degrading a contrast ratio.

### SUMMARY OF THE DISCLOSURE

The present disclosure provides a simple photo-luminescence (PL)-liquid crystal display (LCD) designed to reduce difference in optical characteristics between pixels.

The present invention also may provide a PL-LCD that is capable of displaying a high quality image by suppressing a reduction in contrast ratio due to ambient light.

According to an aspect of the present invention, there may be provided a PL LCD including: a backlight generating blue light; liquid crystals defining a plurality of red, green, and blue pixels and switching blue light from the backlight to control the passage of the blue light through the pixels defined for each color and a liquid crystal driving unit driving the liquid crystals; a red phosphor layer corresponding to the red pixel, the red phosphor layer being excited by the blue light to emit red light; a green phosphor layer corresponding to the green pixel, the green phosphor layer being excited by the blue light to emit green light; and a blue photo-luminescent nano-dot (ND) layer corresponding to the blue pixel, the blue photo-luminescent ND layer being excited by the blue light to emit blue light.

The blue light may have a wavelength of 430 to 480 nm. The backlight includes a blue light-emitting diode (LED) light source. The blue photo-luminescent ND layer may be formed of cadmium sulfide (CdS).

The PL LCD may further include an ultraviolet (UV) filter blocking external UV and preventing absorption of UV into the red and green phosphor layers and the blue ND layer. The UV filter may use a chemical blocking agent for absorbing UV, such as para-aminobenzoic acid (PABA) precursor, cinnamate precursor, salicylic acid precursor, benzophenone and its precursor or antharanilate and its precursor, or a physical blocking agent for reflecting and scattering incident UV, such as zinc oxide, titanium dioxide, iron oxide or magnesium oxide.

### BRIEF DESCRIPTION OF THE DRAWINGS

The above and other features and advantages of the present invention are described in detailed exemplary embodiments thereof with reference to the attached drawings in which:

FIG. 1 is a cross-sectional view of a liquid crystal display (LCD) according to a first embodiment of the present invention;

FIG. 2 shows an example of the backlight of the LCD of FIG. 1;

FIG. 3 shows another example of the backlight of the LCD of FIG. 1;

FIG. 4 is a cross-sectional view of a LCD according to a second embodiment of the present invention;

FIG. 5 is a cross-sectional view showing the structure of a switching element and a pixel electrode in a LCD according to the present invention;

FIG. 6 is a graph showing a change in photo-luminescence (PL) intensity in CdS nano-dot (ND); and

FIG. 7 is a graph showing emission intensity for phosphors excited by ultraviolet (UV) contained in ambient light in a conventional PL-LCD.

### DETAILED DESCRIPTION OF EXEMPLARY EMBODIMENTS

The present invention will now be described more fully with reference to the accompanying drawings, in which exemplary embodiments of the invention are shown.

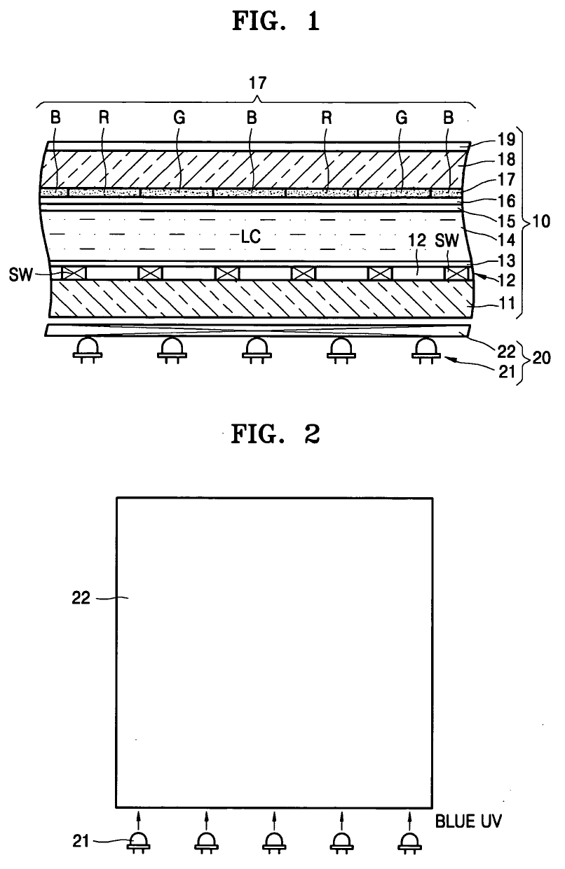

Referring to FIG. 1, a liquid crystal display (LCD) according to a first embodiment of the present invention includes a display panel 10 and a blue backlight 20. For example, the blue backlight 20 may use a blue light-emitting diode (LED) generating blue visible light having 460 nm wavelength. The display panel 10 includes a front substrate 18 and a rear substrate 11 spaced from each other by a predetermined distance and a liquid crystal (LC) layer 14 sandwiched between the front and rear substrates 18 and 11.

A light-emitting layer 17 containing red phosphor layers R, green phosphor layers G, and blue nano-dot (ND) layers B is disposed on an inner surface of the front substrate 18. A common electrode 16 and an upper alignment layer 15 are sequentially formed on the light-emitting layer 17. A liquid crystal driving circuit including a plurality of thin-film transistor (TFT) switching elements SW and a plurality of pixel electrodes 12 and a lower alignment layer 13 are sequentially disposed on the rear substrate 11. Here, the phosphor layers R and G and the blue ND layer B are excited by 460 nm blue light from the backlight 20 and emit light. For example, the ND layer B is excited by 460 nm blue light from the backlight 20 and generates light near 460 nm. Light passing through the LC layer 14 and incident on the ND layer B has a polarization component and light generated by the ND layer B has an elliptical or circular polarization component. Because the light generated by the ND layer B has no linear polarization component, the ND layer B for the blue pixel provides a wide viewing angle and the generated light has non-directional light or non-orientative light.

The blue ND (or quantum dot) refers to a semiconductor particle of a predetermined size showing a quantum confinement effect. The quantum dots have a diameter of 1 to 10 nm and may be synthesized by a wet chemistry method. Here, the wet chemistry method is a commonly known technique that allows particles to grow by mixing a precursor material in an organic solvent.

For example, the quantum dots may be formed of a Il-VI compound such as cadmium selenide (CdSe), cadmium telluride (CdTe), cadmium sulfide (CdS), zinc selenide (ZnSe), zinc telluride (ZnTe), zinc sulfide (ZnS), mercury telluride (HgTe), or mercury sulfide (HgS). The quantum dots may have a core-shell structure in which the core includes one compound selected from the group consisting of CdSe, CdTe, CdS, ZnSe, ZnTe, ZnS, HgTe, and HgS and the shell includes one compound selected from the group consisting of CdSe, CdTe, CdS, ZnSe, ZnTe, ZnS, HgTe, and HgS. The quantum dots may also be formed of a III-V compound such as indium phosphide (InP).

An ultraviolet (UV) filter 19 is disposed on an outer surface of the front substrate 18. The UV filter 19, may use a chemical blocking agent absorbing UV, such as para-aminobenzoic acid (PABA) precursor, cinnamate precursor, salicylic acid precursor, benzophenone and its precursor or antharanilate and its precursor, or a physical blocking agent reflecting and scattering incident UV, such as zinc oxide, titanium dioxide, iron oxide or magnesium oxide. The UV filter 19 prevents UV light that causes unnecessary light emission from the light-emitting layer 17 from entering the light-emitting layer 17. The UV light to be blocked is in the near-blue region shorter than 460 nm light emitted by the blue ND. For example, the UV light may have a wavelength of less than 400 nm.

The blue backlight 20 located near the bottom surface of the rear substrate 11 has a blue lamp 21 and a light guide/diffusion element 22. As described above, the lamp 21 may be a blue LED. The light guide/diffusion element 22 guides and uniformly diffuses blue light from the lamp 21 toward the rear substrate 11.

The light guide/diffusion element 22 is optional and the lamp 21 has a size corresponding to the entire surface of the rear substrate 11. For example, when the LEDs are used as the lamp 21, a plurality of LEDs may be densely arranged in a two-dimensional array. A light source supplying light over the entire surface of the LCD in this way is needed to achieve a large-screen LCD.

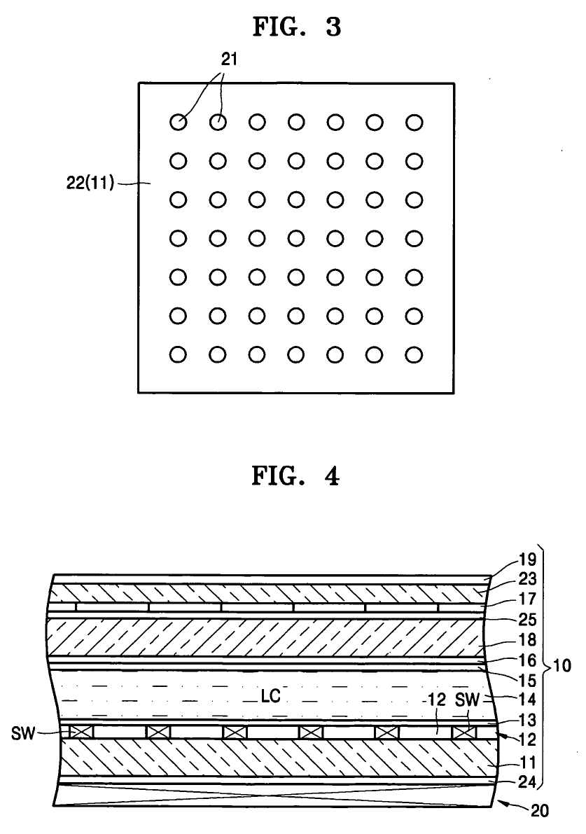

When the lamp 21 is an array of LEDs, the LEDs 21 may be arranged along a line parallel to one edge of the light guide/diffusion element 22 as in an edge light type backlight shown in FIG. 2. Alternatively, as shown in FIG. 3, the LEDs 21 may be arranged on the entire surface of the light guide/diffusion element 22 corresponding to the entire surface of the rear substrate 11.

FIG. 4 is a cross-sectional view of a LCD according to a second embodiment of the present invention. The difference between the LCDs of the first and second embodiments lies in the position of a light-emitting layer 17 and a UV filter 19. Referring to FIG. 4, the LCD includes a display panel 10 and a blue backlight 20. The display panel 10 includes a front substrate 18 and a rear substrate 11 spaced from each other by a predetermined distance and a LC layer 14 sandwiched between the front and rear substrates 18 and 11. A common electrode 16 and an upper alignment layer 15 are sequentially formed on a bottom surface of the front substrate 18. Polarization plates 25 and 24 are respectively disposed on a top surface of the front substrate 18 and a bottom surface of the rear substrate 11. A light-emitting layer 17 overlies the polarization plate 25 and emits color light when irradiated with UV light. The light-emitting layer 17 includes red and green phosphor layers and a blue ND layer, which are commonly known to emit color light by absorbing 460 nm blue light as described above.

The light-emitting layer 17 is covered by a protective substrate 23 and the UV filter 19 is disposed on the protective substrate 23 and blocks UV light of a wavelength shorter than light generated by the ND layer B as described above. The UV filter 19 may be a chemical blocking agent for absorbing UV, such as PABA precursor, cinnamate precursor, salicylic acid precursor, benzophenone and its precursor or antharanilate and its precursor, or a physical blocking agent for reflecting and scattering incident UV, such as zinc oxide, titanium dioxide, iron oxide or magnesium oxide. The UV filter 19 prevents UV light that causes unnecessary light emission from the light-emitting layer 17 from entering the light-emitting layer 17.

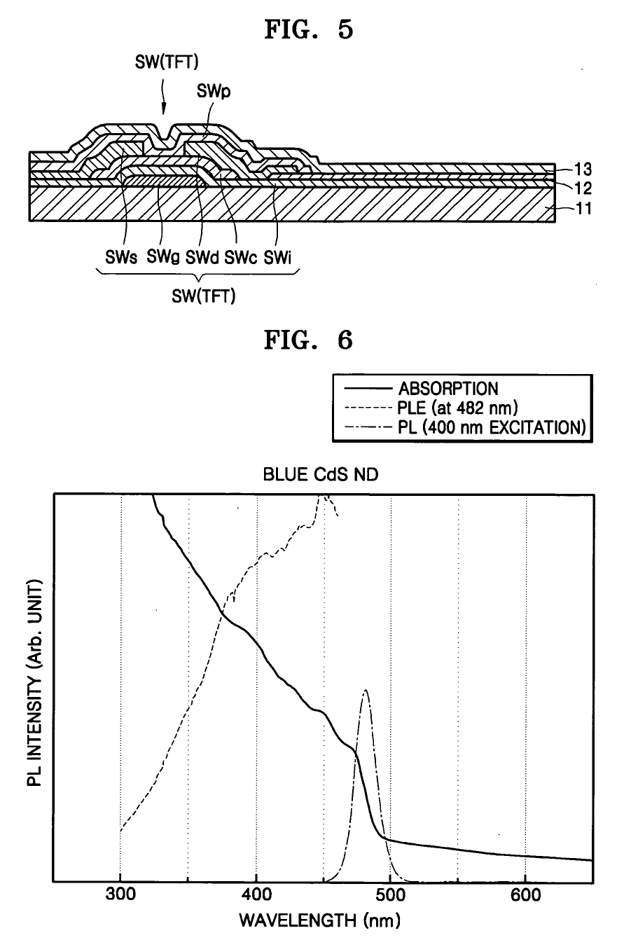

FIG. 5 is a cross-sectional view showing a vertical structure of a switching element SW that is a thin film transistor (TFT) and a pixel electrode 12 connected to the switching element SW in a LCD according to the present invention. Referring to FIG. 5, the TFT has a bottom gate structure in which a gate SWg is disposed below a silicon channel SWc. More specifically, the gate SWg is formed on one side of a substrate 11 and a gate insulating layer SWi is formed over the substrate 11 on which the gate SWg has been formed. The silicon channel SWc is formed on the gate insulating layer SWi immediately above the gate SWg and a transparent indium tin oxide (ITO) pixel electrode 12 is located on the gate insulating layer SWi and adjacent to the silicon channel SWc. A source SWs and a drain SWd are formed on either side of the silicon channel SWc and a passivation layer SWp is formed on the source SWs and drain SWd. The drain SWd extends onto and is electrically connected to the pixel electrode 12. A lower alignment layer 13 is formed on the TFT switching element SW and the pixel electrode 12 and is in contact with LC and aligns the LC to a specific orientation.

As described above, in a LCD according to the present invention, the red phosphor is selected from the group consisting of (Sr,CaS):Eu2+, (Sr,Ca)2Si5N8:Eu2+, and Mg4GeO 5.5 F:Mn 4+ and the green phosphor is selected from the group consisting of SrGa2S4:Eu2+, (Ba,Sr)SiO4:Eu2+, MgSi2O7, SrAl2O4:Eu2+, Ca8Mg(SiO4)₄Cl2:Eu 2+, and (Cr,Ca)(Al,Si)₂:Eu 2+.

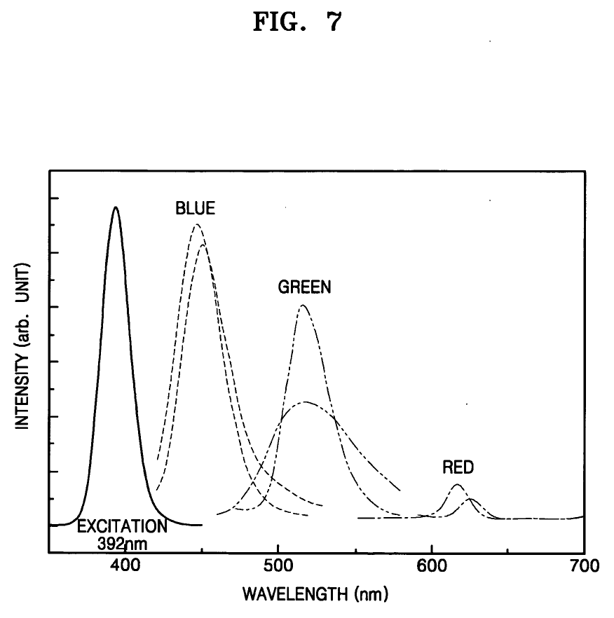

FIG. 6 is a graph showing a change in photo-luminescence (PL) intensity in CdS that is a photo-luminescent material. Referring to FIG. 6, the CdS ND shows maximum PL intensity at a wavelength near 480 nm by absorbing up to light having a wavelength near 480 nm. Thus, by using the property of the ND, polarized blue light can be converted into unpolarized light having a similar wavelength.

FIG. 7 is a graph showing emission intensity for phosphors excited by 392 nm UV contained in ambient light such as bright illumination or sunlight. To obtain the result shown in FIG. 7, two phosphors available from two different manufacturers were used as conventional UV-excited phosphor for each color and a 392 nm LED was used as a light source.

As evident from FIG. 7, when ambient UV light having a wavelength of about 392 nm is excited, red, green, and blue phosphors, are excited with two different kinds of blue phosphors emitting the shortest wavelength blue light having similar intensities. The two green phosphors available from different manufacturers respectively generated green light with high and low intensities. The red phosphors emitted light having very low intensities.

When PL-LCD is exposed to an environment in which ambient light intensity is very high, light emission not contributing to displaying an image on a screen occurs across the entire surface of the display, thus degrading the contrast for each color. In particular, blue and green have a significantly lower contrast ratio than red.

Thus, the PL-LCD according to the present invention uses a UV filter to prevent external light to enter a light-emitting layer of the LCD. As described above, the UV filter uses a chemical or physical blocking agent to suppress degradation in the contrast ratio due to external light.

For example, a wavelength of light blocked by a UV filter is shorter than wavelengths in the visible blue band including a wavelength band near 400 nm necessary for excitation of a light-emitting layer and does not contain a visible light region used for displaying an image.

While the present invention has been described with reference to a TFT active matrix LCD, a simple matrix LCD without a switching element may be used.

The PL-LCD of the present invention improves the drawback of a conventional LCD without a phosphor for a blue pixel while preventing excitation of the light-emitting layer due to external light and the resulting degradation in the contrast ratio that are drawbacks of a typical PL-LCD. Thus, the PL-LCD provides a high quality image with high brightness and a high light utilization efficiency.

While the present invention has been particularly shown and described with reference to exemplary embodiments thereof, the invention should not be construed as being limited to the embodiments set forth herein; rather, these embodiments are provided so that this disclosure will be thorough and complete, and will fully convey the concept of the invention to those skilled in the art. It will be understood by those of ordinary skill in the art that various changes in structure and arrangement may be made therein without departing from the spirit and scope of the present invention as defined by the following claims.

What is claimed is:

1. A photo-luminescence (PL) liquid crystal display (LCD), comprising:
a backlight generating blue light;
liquid crystals defining a plurality of red, green, and blue pixels and switching blue light emitted from the backlight to control the passage of the blue light through the pixels defined for each color and a liquid crystal driving unit driving the liquid crystals;
a red phosphor layer corresponding to the red pixel, the red phosphor layer being excited by the blue light to emit red light;
a green phosphor layer corresponding to the green pixel, the green phosphor layer being excited by the blue light to emit green light; and
a blue photo-luminescent nano-dot (ND) layer corresponding to the blue pixel, the blue photo-luminescent ND layer being excited by the blue light to emit blue light.

2. The PL LCD of claim 1, wherein the blue photo-luminescent ND layer is formed of one of II-IV and III-V compounds.

3. The PL LCD of claim 1, wherein the red phosphor layer is made of one selected from the group consisting of (Sr,CaS):Eu2+, (Sr,Ca)₂Si5N8:Eu2+, and Mg4GeO 5.5 F:Mn4+,
wherein the green phosphor layer is made of one selected from the group consisting of SrGa2S4:Eu2+, (Ba,Sr)SiO4:Eu2+, MgSi2O7, SrAl2O4:Eu2+, Ca8Mg(SiO4)₄Cl2:Eu2+, and (Cr,Ca)(Al,Si)₂:Eu2+, and
wherein the blue photo-luminescent ND layer is formed of one of II-IV and III-V compounds.

4. The PL LCD of claim 1, further comprising an ultraviolet (UV) filter blocking external UV and preventing absorption of UV into the red and green phosphor layers and the blue ND layer.

5. The PL LCD of claim 4, wherein the UV filter is formed of one selected among the group consisting of para-aminobenzoic acid (PABA) precursor, cinnamate precursor, salicylic acid precursor, benzophenone and its precursor, and antharanilate and its precursor.

6. The PL LCD of claim 4, wherein the UV filter is formed of one selected from the group consisting of zinc oxide, titanium dioxide, iron oxide, and magnesium oxide.

7. The PL LCD of claim 2, wherein the red phosphor layer is made of one selected from the group consisting of (Sr,CaS):Eu2+, (Sr,Ca)₂Si5N8:Eu2+, and Mg4GeO 5.5 F:Mn4+,
wherein the green phosphor layer is made of one selected from the group consisting of SrGa2S4:Eu2+, (Ba,Sr)SiO4:Eu2+, MgSi2O7, SrAl2O4:Eu2+, Ca8Mg(SiO4)₄Cl2:Eu2+, and (Cr,Ca)(Al,Si)₂:Eu2+, and
wherein the blue photo-luminescent ND layer is formed of one of II-IV and III-V compounds.

8. The PL LCD of claim 2, further comprising an ultraviolet (UV) filter blocking external UV and preventing absorption of UV into the red and green phosphor layers and the blue ND layer.
